(19) United States
(12) Patent Application Publication
(10) Pub. No.: US 2005/0202992 A1
(43) Pub. Date: Sep. 15, 2005

(54) Perfumed detergent tablets

(75) Inventors: Maria Leonor Grandio Portabales, Bruxelles (BE); Michael Green, Newcastle Upon Tyne (GB); Jose Maria Velazquez, Sunninghill (GB); Miguel Estrella de Castro, Bruxelles (BE); Jean Wevers, Steenhuffel (BE)

Correspondence Address: THE PROCTER & GAMBLE COMPANY;INTELLECTUAL PROPERTY DIVISION, WINTON HILL TECHNICAL CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/078,102

(22) Filed: Mar. 11, 2005

(30) Foreign Application Priority Data
Mar. 11, 2004 (EP) 04447060.7

(51) Int. Cl. C11D 17/00

(52) U.S. Cl. 510/446

(57) ABSTRACT

The present invention is directed to detergent tablets with improved perfume stability. It relates to a detergent tablet comprising at least 2 discrete regions and 0.05% to 10% by weight of the detergent tablet, of a perfume particle comprising a porous carrier material and a perfume contained in the pores of said porous carrier material; wherein the perfume particle is comprised at a greater concentration in one region of the tablet than in another region thereof.

### FIELD OF THE INVENTION

The present invention relates to detergent tablets having improved perfume stability and delivering a longer-lasting dry fabric odour benefit.

### BACKGROUND OF THE INVENTION

Compositions in form of tablets, e.g., especially for a laundry or an automatic dishwashing operation, become increasingly popular with consumers as they offer simple dosing, easy storage and handling. Also for detergent manufacturers, tablet compositions have many benefits such as reduced transportation costs, handling costs and storage costs. Tablets are typically formed by compression of the various components. The tablets produced must be sufficiently robust to be able to withstand handling and transportation without sustaining damage. In addition, the tablets must also dissolve quickly so that the detergent components are released into the wash water as soon as possible at the beginning of the wash cycle. Such performance aspects are an important feature of the detergent tablets, and although they are not necessarily the focus of the present invention, they are inherently a part of the background of the present invention.

Most consumers have come to expect scented laundry products and to expect that fabrics which have been laundered also to have a pleasing fragrance. Perfume additives make laundry compositions more aesthetically pleasing to the consumer, and in some cases the perfume imparts a pleasant fragrance to fabrics treated therewith. However, the amount of perfume carryover from an aqueous laundry bath onto fabrics is often marginal. Industry has long searched for an effective perfume delivery system for use in laundry products that provides a long-lasting, storage-stable fragrance to the product, as well as effective deposition of fragrance on laundered fabrics. Various techniques have been developed to hinder or delay the release of perfume from such compositions so that they will remain aesthetically pleasing for a longer length of time. To date, however, few of the methods deliver significant fabric odour benefits after prolonged storage of the fabric.

Laundry consumers expect the fabrics to have a pleasant smell not only after the washing cycle, at the damp stage, but also during and after drying (dry fabric odor). The present invention relates to detergent tablet that provides lasting perfume benefits to fabrics that have been laundered with this product. Moreover, this composition minimizes the losses of perfume during both production process, storage over time and laundering.

There has been a continuing search for methods and compositions that will effectively and efficiently deliver perfume from a laundry bath onto fabric surfaces. Various methods of perfume delivery have been developed involving protection of the perfume through the wash cycle, with release of the perfume onto fabrics. For example, perfumes have been adsorbed onto a clay or zeolite material that is then admixed into particulate detergent compositions: U.S. Pat. No. 4,539,135 discloses particulate laundry compounds comprising a clay or zeolite material carrying perfume. Combinations of perfumes generally with larger pore size zeolites such as zeolite X and Y are also taught in the art. East German Patent Publication No. 248,508, relates to perfume dispensers containing a faujasite-type zeolite (e.g., zeolite X and Y) loaded with perfume. Also, East German Patent Publication No. 137,599, published Sep. 12, 1979 teaches compositions for use in powdered washing agents to provide thermoregulated release of perfume. Zeolites A, X and Y are taught for use in these compositions.

While the adsorption of perfume onto zeolite or polymeric carriers may perhaps provide some improvement over the addition of neat perfume admixed with detergent compositions, the industry is still searching for improvements in the length of storage time of the laundry compositions without loss of perfume characteristics such as intensity, the amount of fragrance delivered to fabrics, and perhaps most importantly in the duration of the perfume scent on the treated fabric surfaces. As described below, the release of perfume from a zeolite carrier material is a moisture activated release. A complicating factor in the use of such materials is the pre-mature release of perfume components early during the laundering process.

Several solutions such as the coating/encapsulation of the perfume particle, have been proposed to prevent the premature release of the perfume component from the carrier. WO 94/28107 teaches compositions which comprise zeolites having pore size of at least 6 Angstroms, perfume releaseably incorporated in the pores of the zeolite, and a matrix coated on the perfumed zeolite, the matrix comprising a water-soluble composition comprising from 0%-80% by weight of at least one solid polyol containing more than 3 hydroxyl moieties and from 20%-100% by weight of a fluid diol or polyol, in which the perfume is substantially insoluble and in which the solid polyol is substantially soluble. WO 97/34982 discloses particles comprising perfume loaded zeolite and a release barrier, which is an agent derived from a wax and having a size larger than the size of the pore openings of the zeolite carrier. WO01/40430 a particle comprising a core of a porous carrier material containing an additive, such as a perfume, in its pores; a first coating of a hydrophobic oil encapsulating said core, and a second coating of a water-soluble but oil-insoluble material, such as starch or modified starch, encapsulating the hydrophobic-oil coated core. WO02/090481 provides for a temperature and humidity stable unit dose perfume delivery article that comprises a perfume composition, a material selected from a perfume carrier, preferably zeolite, a hydrating material and mixtures thereof, and a humidity resistant package, wherein at least 30% by volume of the components are in the form of fine powders or particulates having a mean particle size of less than 100 microns. WO02/089862 describes an air freshening composition that includes porous carrier particles having a perfume composition entrapped therein, a second component for retarding the absorption and/or adsorption of water and/or for providing moisture to the porous carrier particles, and optionally, a third component selected from free perfume, colorant, disintegrant, water swelling agent and/or porosity modifier.

An objective of the present invention is to provide detergent tablets which have sufficient hardness to survive handling and transportation, will rapidly dissolve in the wash water without leaving residue, and will release perfume components onto the fabric not only during the washing cycle but as well during and after the drying stage, while ensuring the stability of the detergent tablet from its preparation to the end use. In particular, an objective of the present invention is to ensure the long-term stability of the perfume components of detergent tablets. The present invention provides for improved retention of the perfume in the zeolite carrier material such that more perfume is retained on fabric through the laundering process to be released from the dry fabric in the presence of atmospheric moisture or humidity. The present invention also provides the benefit of continued odour release from laundered fabrics when exposed humidity while being stored, dried or ironed, providing an enduring fragrance.

### SUMMARY OF THE INVENTION

The present invention relates to a detergent tablet comprising from 0.05% to 10%, preferably from 0.1% to 5%, more preferably from 0.1% to 3% by weight of the total detergent tablet of a perfume particle comprising a core of a porous material comprising a perfume in its pores; wherein the perfume particle is comprised at a greater concentration in one region of the tablet (region 2) than in another region thereof (region 1).

### BRIEF DESCRIPTION OF THE DRAWINGS

FIG. 1 shows a cross-sectional view of an embodiment of the detergent tablet of the present invention wherein the first region (1) is the detergent tablet core and the second region comprising the perfume particle, is in the form of a central bead (2).

FIG. 2 shows a cross-sectional view of an embodiment of the detergent tablet of the present invention wherein the first region (1) is the detergent tablet core and the second region comprising the perfume particle, is in the form of thin layer (2).

FIG. 3 shows a cross-sectional view of an embodiment of the detergent tablet of the present invention wherein the first region (1) is the detergent tablet core and the second region comprising the perfume particle, is in the form of 2 thin layers (2 and 3).

FIG. 4 shows a cross-sectional view of an embodiment of the detergent tablet of the present invention wherein the first region (1) is the detergent tablet core and the second region comprising the perfume particle, is in the form of a thick layer (2).

FIG. 5 shows a cross-sectional view of an embodiment of the detergent tablet of the present invention wherein the first region (1) is the detergent tablet core and the second region comprising the perfume particle, is in the form of a central dimple (2).

FIG. 6 shows a cross-sectional view of an embodiment of the detergent tablet of the present invention wherein the first region (1) is the detergent tablet core and the second region comprising the perfume particle, is in the form of a plurality of discrete particles (2) located inside the first region (1).

FIG. 7 shows a perspective view of an embodiment of the detergent tablet of the present invention wherein the first region (1) is the detergent tablet core and the second region comprising the perfume particle, is in the form of a plurality of discrete particles (2) protuding at the surface of the first region.

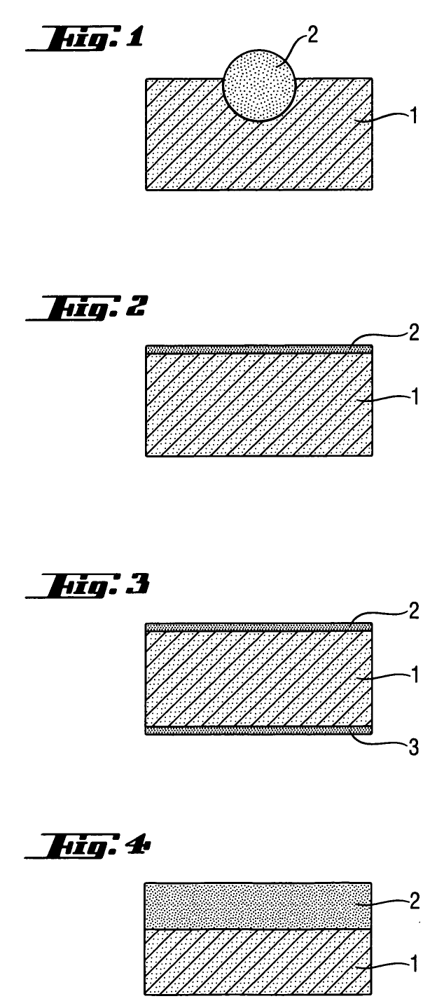

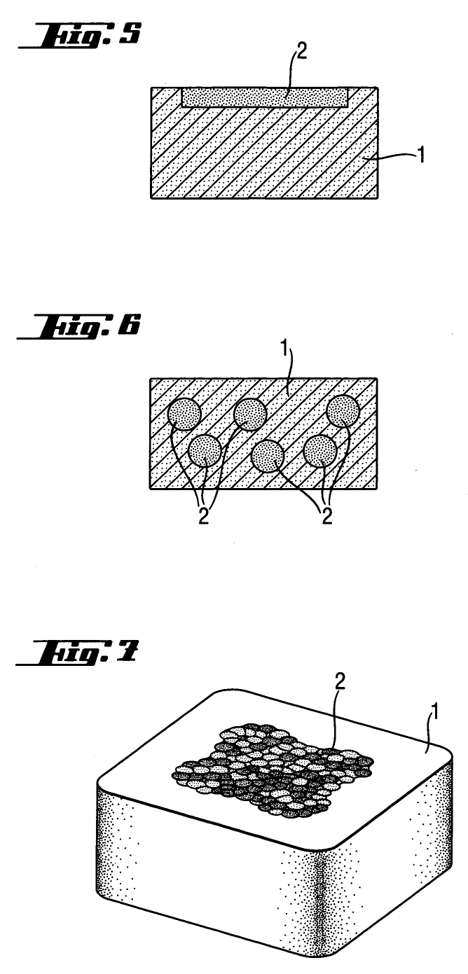

### DETAILED DESCRIPTION OF THE INVENTION

The articles of the present invention have sufficient hardness to survive handling and transportation, will rapidly dissolve in water during a short cycle washing and/or rinsing process without leaving residue, and will deposit perfume components onto the fabric and provide for a slow release of those components when exposed to atmospheric moisture. It is believed that excellent long-term stability of perfume particles is insured by separating the perfume particle into a discrete region of the detergent tablet.

The porous carrier material is typically selected from zeolites, macroporous zeolites, amorphous silicates, crystalline nonlayer silicates, layer silicates, silica, calcium carbonates, calcium/sodium carbonate double salts, sodium carbonates, clays, sodalites, alkali metal phosphates, chitin microbeads, carboxyalkylcelluloses, carboxyalkylstarches, cyclodextrins, porous starches, and mixtures thereof. Preferably the carrier material is a zeolite such as Zeolite X, Zeolite Y, and mixtures thereof. Particularly preferred porous carriers are zeolite particles with a nominal pore size of at least about 6 Angstroms to effectively incorporate perfume into their pores.

Without wishing to be limited by theory, it is believed that these zeolites provide a channel or cage-like structure in which the perfume molecules are trapped. Unfortunately, such perfumed zeolites are not sufficiently storage-stable for commercial use in tablet detergents, particularly due to premature release of perfume upon moisture absorption. However, it has now been discovered that the perfume-loaded zeolite can be stabilised when formulated into a separated discrete region of the tablet detergent. Without wishing to be bound by theory, it is believed that the formulation of the perfume particle into a discrete region of the tablet provides a physical separation from the remaining of the detergent composition and a further barrier to moisture uptake and therefore provides an improved stability of the perfume loaded zeolite. Thus, the perfume substantially remains within the pores of the zeolite particles.

It is also believed that since the perfume is incorporated into the relatively large zeolite pores, it has better perfume retention through the washing process than other smaller pore size zeolites in which the perfume is predominately adsorbed on the zeolite surface.

Preferably, the perfume particle is a perfume-loaded zeolite (PLZ). Preferably, the perfume particle of the present invention have a hygroscopicity value of less than 80%. The “hygroscopicity value”, as used herein, means the level of moisture uptake by the particles, as measured by the percent increase in weight of the particles under the following test method. The hygroscopicity value required for the present invention particles is determined by placing 2 grams of particles in an open container petri dish under conditions of 90° F. and 80% relative humidity for a period of 4 weeks. The percent increase in weight of the particles at the end of this time is the particles' hygroscopicity value as used herein. Preferred particles of the present invention have a hygroscopicity value of less than 50%, more preferably less than 30%.

The perfume particle typically comprises from 1% to 60% of perfume, preferably from 1% to 30%, more preferably from 10% to 20% by weight of perfume particle; and from 40% to 99% of the carrier, preferably from 70% to 99%, more preferably from 80% to 90% by weight of the perfume particle.

Perfume Particle

The perfume particle comprises a porous carrier material and a perfume loaded into said carrier material. It will be encompassed in the detergent tablet of the present invention at a level of from 0.05% to 10%, preferably from 0.1% to 5%, more preferably from 0.1% to 3% by weight of the total detergent tablet.

Such ingredients may be mixed in a number of different ways. At laboratory scale, basic equipment used for this purpose can vary from a 10-20 g coffee grinder to a 100-500 g food processor or even a 200-1000 g kitchen mixer. Procedure consists of placing the carrier material particles (zeolite) in the equipment and pouring the laundry additive at the same time that mixing occurs. Mixing time is from 0.5 to 15 minutes. The loaded carrier material (zeolite) is then allowed to rest for a period from 0.5 to 48 hours before further processing. During the loading process when heating occurs, cool jacketing may be used as an option. At pilot plant level, suitable equipment is a mixer of the Littleford type, which is a batch type mixer with plows and chopper blades that operate at high RPM's, to continuously mix the powder or mixture of powders while liquid perfume oil is being sprayed thereon.

Porous Carrier Material

The porous carrier material, as used herein, means any material capable of supporting (e.g., by adsorption into the pores) the perfume of the present invention. Such materials include porous solids such as zeolites. Preferred zeolites are selected from zeolite X, zeolite Y and mixtures thereof. The term “zeolite” used herein refers to a crystalline aluminosilicate material. The structural formula of a zeolite is based on the crystal unit cell, the smallest unit of structure represented by Mm/n[(AlO2)m(SiO2)y].xH2O where n is the valence of the cation M, x is the number of water molecules per unit cell, m and y are the total number of tetrahedra per unit cell, and y/m is 1 to 100. Most preferably, y/m is 1 to 5. The cation M can be Group IA and Group IIA elements, such as sodium, potassium, magnesium, and calcium.

A zeolite useful herein is a faujasite-type zeolite, including Type X Zeolite or Type Y Zeolite, both with a pore size typically in the range of from 4 to 10 Angstrom units, preferably 8 Angstrom units.

The aluminosilicate zeolite materials useful for this invention are commercially available. Methods for producing X and Y-type zeolites are well-known and available in standard texts. Preferred synthetic crystalline aluminosilicate materials useful herein are available under the designation Type X or Type Y.

In a preferred embodiment, the crystalline aluminosilicate material is Type X and is selected from the following:
(I) Na₈₆[AlO₂]₈₆. (SiO₂)₁₀₆].xH₂O,
(II) K₈₆[AlO₂]₈₆.(SiO₂)₁₀₆].xH₂O,
(III) Ca₄₀Na₆[AlO₂] ₈₆.(SiO₂)₁₀₆].xH₂O,
(IV) Sr₂₁Ba₂₂[AlO₂]₈₆.(SiO₂)₁₀₆].xH₂O,
   and mixtures thereof, wherein x is from 0 to 276. Zeolites of Formula (I) and (II) have a nominal pore size or opening of 8.4 Angstroms units. Zeolites of Formula (III) and (IV) have a nominal pore size or opening of 8.0 Angstroms units.

In another preferred embodiment, the crystalline aluminosilicate material is Type Y and is selected from the following:
(V) Na₅₆[AlO₂]₅₆.(SiO₂)₁₃₆].xH₂O
(VI) K₅₆[AlO₂]₅₆.(SiO₂)₁₃₆].xH₂O,
   and mixtures thereof, wherein x is from 0 to 276. Zeolites of Formula (V) and (VI) have a nominal pore size or opening of 8.0 Angstroms units.

In yet another embodiment, the class of zeolites known as, “Zeolite MAP” may also be employed in the present invention. Such zeolites are described in on pages 5 to 8 of WO95/27030 (published on Oct. 12, 1995 by the Procter & Gamble Company).

Zeolites used in the present invention are in particle form having an average particle size from 0.5 microns to 120 microns, preferably from 0.5 microns to 30 microns, as measured by standard particle size analysis technique. The size of the zeolite particles allows them to be entrained in the fabrics with which they come in contact. Once established on the fabric surface, the zeolites can begin to release their incorporated laundry agents, especially when subjected to heat or humid conditions.

Perfume

As used herein the term “perfume” is used to indicate any odoriferous material which is subsequently released into the aqueous bath and/or onto fabrics or other surfaces contacted therewith. The perfume will most often be liquid at ambient temperatures. A wide variety of chemicals are known for perfume uses, including materials such as aldehydes, especially C6-C14 aliphatic aldehydes, C6-C14 acyclic terpene aldehydes and mixtures thereof, ketones, alcohols and esters. More commonly, naturally occurring plant and animal oils and exudates comprising complex mixtures of various chemical components are known for use as perfumes. The perfumes herein can be relatively simple in their compositions or can comprise highly sophisticated complex mixtures of natural and synthetic chemical components, all chosen to provide any desired odor. Typical perfumes can comprise, for example, woody/earthy bases containing exotic materials such as sandalwood, civet and patchouli oil. The perfumes can be of a light floral fragrance, e.g., rose extract, violet extract, and lilac. The perfumes can also be formulated to provide desirable fruity odors, e.g., lime, lemon, and orange. Any chemically compatible material which exudes a pleasant or otherwise desirable odor can be used in the perfumed compositions herein.

For purposes of the present invention, preferred perfumes are those which have the ability to be incorporated into the pores of the carrier, and hence their utility as components for delivery from the carrier through an aqueous environment. WO 98/41607 describes on page 9, line 16 to page 11, line 1, the characteristic physical parameters of perfume molecules which affect their ability to be incorporated into the pores of a carrier, such as a zeolite: the longest and widest measures, the cross sectional area, the molecular volume molecular area and the shape.

Obviously for the present invention compositions whereby perfume agents are being delivered by the compositions, sensory perception is also required for a benefit to be seen by the consumer. For the present invention perfume delivery particles, the preferred perfume agents have a threshold of noticeability (measured as odor detection thresholds (“ODT”) under carefully controlled GC conditions as described in detail hereinafter) less than or equal to 50 parts per billion (“ppb”). Agents with ODTs above 50 ppb up to 1 part per million (“ppm”) are less preferred. Agents with ODTs above 1 ppm are preferably avoided. Laundry agent perfume mixtures useful for the present invention perfume delivery particles preferably comprise from 0% to 80% of deliverable agents with ODTs above 50 ppb up to 1 ppm, and from 20% to 100% (preferably from 30% to 100%; more preferably from 50% to 100%) of deliverable agents with ODTs less than or equal to 50 ppb.

Also preferred are perfumes carried through the laundry process and thereafter released into the air around the dried fabrics (e.g., such as the space around the fabric during storage). This requires movement of the perfume out of the zeolite pores with subsequent partitioning into the air around the fabric. Preferred perfume agents are therefore further identified on the basis of their volatility. Boiling point is used herein as a measure of volatility and preferred materials have a boiling point less than 300° C. Laundry agent perfume mixtures useful for the present invention preferably comprise at least 50% of deliverable agents with boiling point less than 300° C. (preferably at least 60%; more preferably at least 70%).

In addition, preferred perfume delivery particles herein for use in laundry detergents comprise compositions wherein at least 80%, and more preferably at least 90%, of the deliverable perfume agents have a weighted average ClogP value ranging from 1.0 to 16, and more preferably from 2.0 to 8. Most preferably, the deliverable perfume agents or mixtures have a weighted average ClogP value between 3 and 4. While not wishing to be bound by theory, it is believed that perfume materials having the preferred ClogP values are sufficiently hydrophobic to be held inside the pores of the zeolite carrier and deposited onto fabrics during the wash, yet are able to be released from the zeolite pores at a reasonable rate from dry fabric to provide a noticeable benefit. ClogP values are obtained as follows.

Calculation of ClogP.

These perfume ingredients are characterized by their octanol/water partition coefficient P. The octanol/water partition coefficient of a perfume ingredient is the ratio between its equilibrium concentration in octanol and in water. Since the partition coefficients of most perfume ingredients are large, they are more conveniently given in the form of their logarithm to the base 10, logP. The logP of many perfume ingredients has been reported; for example, the Pomona92 database, available from Daylight Chemical Information Systems, Inc. (Daylight CIS), contains many, along with citations to the original literature.

However, the logp values are most conveniently calculated by the “CLOGP” program, also available from Daylight CIS. This program also lists experimental logp values when they are available in the Pomona92 database. The “calculated logp” (ClogP) is determined by the fragment approach of Hansch and Leo (cf, A. Leo, in Comprehensive Medicinal Chemistry, Vol. 4, C. Hansch, P. G. Sammens, J. B. Taylor and C. A. Ramsden, Eds., p. 295, Pergamon Press, 1990). The fragment approach is based on the chemical structure of each perfume ingredient and takes into account the numbers and types of atoms, the atom connectivity, and chemical bonding. The ClogP values, which are the most reliable and widely used estimates for this physicochemical property, can be used instead of the experimental logp values in the selection of perfume ingredients.

Determination of Odor Detection Thresholds.

The gas chromatograph is characterized to determine the exact volume of material injected by the syringe, the precise split ratio, and the hydrocarbon response using a hydrocarbon standard of known concentration and chain-length distribution. The air flow rate is accurately measured and, assuming the duration of a human inhalation to last 0.2 minutes, the sampled volume is calculated. Since the precise concentration at the detector at any point in time is known, the mass per volume inhaled is known and hence the concentration of material. To determine whether a material has a threshold below 10 ppb, solutions are delivered to the sniff port at the back-calculated concentration. A panelist sniffs the GC effluent and identifies the retention time when odor is noticed. The average over all panelists determines the threshold of noticeability.

The necessary amount of analyte is injected onto the column to achieve a 10 ppb concentration at the detector. Typical gas chromatograph parameters for determining odor detection thresholds are listed below.
GC: 5890 Series 11 with FED detector
7673 Autosampler
Column: J&W Scientific DB-I
Length 30 meters ID 0.25 mm film thickness I micron
Split Injection: 17/1 split ratio
Autosampler: 1.13 microliters per injection
Column Flow: 1.10 mL/minute
Air Flow: 345 mL/minute
Inlet Temp. 245° C.
Detector Temp. 285° C.
Initial Temperature: 50° C.
Rate: 5° C./minute
Final Temperature: 280° C.
Final Time: 6 minutes
Leading assumptions: (i) 0.02 minutes per sniff (ii) GC air adds to sample dilution

Particularly preferred perfumes for use in the present invention are those perfumes referred to as high impact perfumes and characterized by having: (1) a standard B.P. of 300° C. or lower at 760 mm Hg, and; (2) a ClogP, or an experimental logP, of 2 or higher, and; (3) an ODT of less than or equal to 50 ppb.

Incorporation of Perfume in Preferred Zeolite Carrier

The Type X or Type Y Zeolites to be used as the preferred carrier herein preferably contain less than 15% desorbable water, more preferably less than 8% desorbable water, and most preferably less than 5% desorbable water. Such materials may be obtained by first activating/dehydrating by heating to 150-350° C., optionally with reduced pressure (from 0.001-20 Torr). After activation, the agent is slowly and thoroughly mixed with the activated zeolite and, optionally, heated to 60° C. or up to 2 hours to accelerate absorption equilibrium within the zeolite particles. The perfume/zeolite mixture is then cooled to room temperature and is in the form of a free-flowing powder.

The present perfume particles have typically a particle size of from 3 to 100 microns as measured by standard particle size analysis technique.

Stability Testing of Perfume-Loaded Zeolite Particles

Samples of perfume particles (perfume loaded on Zeolite X) are kept in low density polyethylene bags at different storage conditions (27° C. and 60% Relative Humidity (RH), or 35° C. and 80% RH) during one month. After that period the samples are taken out and evaluated organoleptically. Particles are homogenized and dosed according to regional real washing conditions. They are mixed with odorless base granule, previously approved for this kind of test. Perfume intensity scores for the particles are registered in terms of Dry Fabric Odor. Particles with perfume loaded zeolite are able to provide more than 5 points of advantage, in a perfume intensity scale, compared against a similarly aged control with sprayed on perfume alone after 5 to 7 days drying.

Coating and Encapsulation of Loaded Zeolite Particles

The perfume particle of the present invention can further be coated and/or encapsulated. In an embodiment of the present invention, perfume-loaded zeolite particles in the form of a free-flowing powder are thoroughly coated with a hydrophobic oil such as mineral oil or perfume oil. The hydrophobic-oil coated particles are mixed to a solution of modified starch (CAPSUL™, National Starch & Chemicals) and agitated to form an emulsion. The emulsion is then spray-dried using a spray dryer having a spraying system such as co-current with a spinning disk, with vaneless disk, with vaned disk or wheel or with two-fluid mist spray nozzle. Typical conditions involve an inlet temperature of from 120° C. to 220° C. and an outlet temperature of from 50° C. to 220° C.

Further suitable coatings are described in WO01/40430 (published by the Procter and Gamble Company on Jun. 7, 2001). WO01/40430 describes a first coating of a hydrophobic oil and a second coating of a water-soluble but oil-insoluble material, such as starch or modified starch, encapsulating the hydrophobic-oil coated core. Such intermediate oil coating material (p12, line 14 to page 13, line 7) can be a perfume oil which can be the same as or different from the perfume loaded into the carrier, or a non-perfume oil, such as mineral oil; preferably with a weighted average ClogP lower than the weighted average ClogP of the perfume loaded in the pores of the carrier. The external encapsulating material (p13, line 18 to page 15, line 14) is derived from one or more at least partially water soluble or dispersible compounds in an aqueous wash environment and are preferably selected from the following classes of materials: Carbohydrates; All natural or synthetic gums; Chitin and chitosan; Cellulose and cellulose derivatives; Water soluble polymers; Waxes; Plasticizers; Long Chain (C11-C35) fatty compounds; and/or Natural proteins.

Perfume Particle's Other Ingredients

Laundry and cleaning additives or agents can be further included in the perfume particle of the present invention and can be the same as or different from those agents which are typically used to formulate the remainder of the detergent tablets of the present invention.

Detergent Tablet Composition

The detergent tablet of the present invention will comprise at least 2 different regions. The perfume particle is comprised at a greater concentration in one region of the tablet (region 2) than in another region thereof (region 1). In a preferred embodiment, region 1 is the compacted matrix of the detergent tablet and is usually referred to as the core; region 2 is a discrete region that will be in the form of a single or a plurality of coating, insert, dimple, beads, particles . . . In a more preferred embodiment, all perfume particles will be comprised in region 2 of the detergent tablet.

The different regions can either have the same or different colors. Multi-layer tablets having 2 or 3 layers are preferred. Single- and multi-layer tablets having exacavations and/or cavities and/or holes in all sorts of geometrical forms are also included in the present invention. Particularly preferred are tablets in which embedded geometrical shapes such as hemispheres protrude from the surface of the tablet.

In a preferred embodiment, the detergent tablet herein comprise two regions, the first region in the form of a shaped body having at least one mold therein and the second region is in the form of a compressed or shaped body contained, for example by physical or chemical adhesion, within the mold of the first region. More preferably, the perfume particle is comprised within the mold.

In a more preferred aspect of the present invention, the detergent tablet comprises as region 2, a plurality of particles. Such discrete particles comprise the perfume particle as this causes the perfume to be more evenly distributed around the wash thus helping to ensure a more uniform application of the perfume to the fabrics as well as an improved stability of the perfume particle. Preferably the discrete particles comprising the perfume particles, have a average particle size of from 0.5 mm to 10 mm, more preferably from 1.5 mm to 5 mm, even more preferably from 2 mm to 4 mm. The discrete particles can be in any 3-dimensional shape such as in the form of granules, beads, noodles, pellets, compressed tablets, filled sachets, and mixtures thereof. Preferably the particles are in the form of beads. It is preferred that the discrete particles are substantially spherical in shape.

The discrete region comprising the perfume particle can comprise in addition to the perfume particle, further ingredients such as fabric softening agent, a binder, a dissolution aid, a builder, an alkalinity source, a dye, a free perfume and/or an effervescent system (as described below in more details).

When formulated as discrete particles, such particles should preferably be strong enough to withstand the compression step of the tablet making process. The resistance to compression can be controlled or improved by adding certain ingredients, such as dissolution aids, silicas, or porous carriers such as Zeolite X or Y. Binders can also be selected to reduce the deformability of the region can be selected from (i) Polymeric materials include polyvinylpyrrolidones with an average molecular weight of from 12,000 to 700,000, polyethylene glycols with an average molecular weight of from 600 to 10,000, Copolymers of maleic anhydride with ethylene, methylvinyl ether, methacrylic acid or acrylic acid; (ii) Sugars, sugar acids, sugar alcohols, and preferably sorbitol. The binder may optionally be blended with one or more additional compounds such as viscosity modifiers or structuring agents such as lewis acids, preferably boric acid.

Formulations

The detergent tablet of the present invention can be formulated for use in any cleaning process such as dishwashing and laundry, preferably for use in a fabric washing process.

The detergent tablet can comprise a wide variety of different ingredients, such as building agents, effervescent system, enzymes, dissolution aids, disintegrants, bleaching agents, suds supressors, surfactants (nonionic, anionic, cationic, amphoteric, and/or zwitterionic), fabric softening agents, alkalinity sources, colorants, perfumes, lime soap dispersants, organic polymeric compounds including polymeric dye transfer inhibiting agents, crystal growth inhibitors, anti-redeposition agents, soil release polymers, hydrotropes, fluorescents, heavy metal ion sequestrants, metal ion salts, enzyme stabilisers, corrosion inhibitors, optical brighteners, and combinations thereof.

When formulated as compositions suitable for use in a laundry machine washing method, the compositions herein typically contain both a surfactant and a builder compound and additionally one or more detergent components preferably selected from organic polymeric compounds, bleaching agents, additional enzymes, suds suppressors, dispersants, lime-soap dispersants, soil suspension and anti-redeposition agents and corrosion inhibitors. Laundry compositions can also contain softening agents, as additional detergent components.

The compositions herein can also be used as detergent additive products. Such additive products are intended to supplement or boost the performance of conventional detergent compositions and can be added at any stage of the cleaning process.

The detergent tablets of the present invention are made by tabletting a detergent base powder. The base powder is typically a pre-formed detergent granule. The pre-formed detergent granule may be an agglomerated particle or in any other form. The average particle size of the base powder is typically from 100 μm to 2,000 μm, preferably from 200 μm, or from 300 μm, or from 400 μm, or from 500 μm and preferably to 1,800 μm, or to 1,500 μm, or to 1,200 μm, or to 1,000 μm, or to 800 μm, or to 700 μm. Most preferably, the average particle size of the base powder is from 400 μm to 700 μm. The bulk density of the base powder is typically from 400 g/l to 1,200 g/l, preferably from 500 g/l to 950 μl, more preferably from 600 g/l to 900 μl, and most preferably from 650 g/l to 850 g/l.

Free Perfume

Preferably, the detergent tablet can further comprise a free perfume, i.e. other than the perfume particle of the present invention. The free perfume can be the same as or different from the perfume oil loaded into the carrier. The free perfume will provide the detergent tablet odour, most of the damp fabric odor and a small amount of dry fabric odour. The perfume particle with provide the long lasting dry fabric odour. Since, the free perfume and loaded perfume will give different perfume benefits, it is preferred that the free perfume and loaded perfume are of different compositions. The detergent tablets of the present invention typically comprise a free perfume at a level of 0.05% to 2%, preferably 0.1% to 1% by weight of the total detergent tablet. The free perfume may be blended into the tablet composition (such as by spray-on techniques) along with the perfume-containing particle. Preferably, the free perfume is formulated within the region 2 together with the perfume particle.

Builder Compound

When formulated in a laundry detergent tablet, the base powder herein preferably comprises a builder compound, typically present at a level of from 1% to 80% by weight, preferably from 10% to 70% by weight, most preferably from 20% to 60% by weight of the base powder.

Highly preferred builder compounds for use in the present invention are water-soluble phosphate builders. Specific examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from 6 to 21, and salts of phytic acid.

Examples of partially water soluble builders include the crystalline layered silicates as disclosed for example, in EP-A-0164514, DE-A-3417649 and DE-A-3742043. Examples of largely water insoluble builders include the sodium aluminosilicates. Suitable aluminosilicates include the aluminosilicate zeolites having the unit cell formula Na_{Z}[(AlO₂)_{Z}(SiO₂)y]·H₂O wherein z and y are at least 6; the molar ratio of z to y is from 1.0 to 0.5 and x is at least 5, preferably from 7.5 to 276, more preferably from 10 to 264. The aluminosilicate material are in hydrated form and are preferably crystalline, containing from 10% to 28%, more preferably from 18% to 22% water in bound form.

Surfactant

The base powder herein preferably comprises at least one surfactant, preferably two or more surfactants. The total surfactant concentration is typically from 1% to 80% by weight, preferably from 10% to 70% by weight, most preferably from 20% to 60% by weight of the base powder. Suitable surfactants are selected from anionic, cationic, nonionic ampholytic and zwitterionic surfactants and mixtures thereof.

A typical listing of anionic, nonionic, amphoteric and zwitterionic classes, and species of these surfactants, is given in U.S. Pat. No. 3,929,678 issued to Laughlin and Heuring on Dec. 30, 1975. A list of suitable cationic surfactants is given in U.S. Pat. No. 4,259,217 issued to Murphy on Mar. 31, 1981. A listing of surfactants typically included in laundry detergent compositions is given for example, in EP-A-0414549 and PCT Applications No.s WO 93/08876 and WO 93/08874. Further suitable detergent active compounds are available and are fully described in WO 02/31100 published on Apr. 18, 2002 and assigned to P&G and in the literature, e.g., in “Surface-active agents and detergents”, Vol. I and II, by Schwartz, Perry and Berch.

Disintegration Aid

It is preferred that the detergent tablets herein comprise a disintegration aid, such as:

1. The compositions herein can comprise a disintegrant that will swell on contact with water. Possible disintegrants for use herein include those described in the Handbook of Pharmaceutical Excipients (1986). Examples of suitable disintegrants include clays such as bentonite clay; starch: natural, modified or pregelatinised starch, sodium starch gluconate; gum: agar gum, guar gum, locust bean gum, karaya gum, pectin gum, tragacanth gum; croscarmylose sodium, crospovidone, cellulose, carboxymethyl cellulose, algenic acid and its salts including sodium alginate, silicone dioxide, polyvinylpyrrolidone, soy polysaccharides, ion exchange resins, and mixtures thereof.

2. Preferably the tablets will be coated so that the tablet does not absorb moisture, or absorbs moisture at only a very slow rate. The coating can improve the mechanical characteristics of a shaped composition while maintaining or improving dissolution. This very advantageously applies to multi-layer tablets, whereby the mechanical constraints of processing the multiple phases can be mitigated though the use of the coating, thus improving mechanical integrity of the tablet. The preferred coatings and methods for use herein are described on page 3, line 28 to page 4, line 12 of EP-A-846,754 (published by the Procter & Gamble Company on Jun. 10, 1998). As specified therein, preferred coating ingredients are for example dicarboxylic acids. Particularly suitable dicarboxylic acids are selected from oxalic acid, malonic acid, succinic acid, glutaric acid, adipic acid, pimelic acid, suberic acid, azelaic acid, sebacic acid, undecanedioic acid, dodecanedioic acid, tridecanedioic acid and mixtures thereof. Most preferred is adipic acid. Preferably the coating comprises a disintegrant, as described hereinabove, that will swell on contact with water and break the coating into small pieces. Preferably the coating comprises a cation exchange resins, such as those sold by Purolite under the names Purolite® C100NaMR, a sodium salt sulfonated poly(styenedivinylbenzene) co-polymer and Purolite® C100CaMR, a calcium salt sulfonated poly(styene-divinylbenzene) co-polymer.

3. The compositions herein can comprise an effervescent. As used herein, effervescency means the evolution of bubbles of gas from a liquid, as the result of a chemical reaction between a soluble acid source and an alkali metal carbonate, to produce carbon dioxide gas. The addition of this effervescent to the detergent improves the disintegration time of the compositions. The amount will preferably be from 0.1% to 20%, more preferably from 5% to 20% by weight of composition. Preferably the effervescent should be added as an agglomerate of the different particles or as a compact, and not as separate particles.

4. Further dispersion aid could be provided by using compounds such as sodium acetate, nitrilotriacetic acid and salts thereof or urea. A list of suitable dispersion aid may also be found in Pharmaceutical Dosage Forms: Tablets, Vol. 1, 2nd Edition, Edited by H. A. Lieberman et al, ISBN 0 8044 5. Non-gelling binding can be integrated to the particles forming the tablet in order to facilitate dispersion. They are preferably selected from synthetic organic polymers such as polyethylene glycols, polyvinylpyrrolidones, polyacetates, water-soluble acrylate copolymers, and mixtures thereof. The handbook of Pharmaceutical Excipients; 2nd Edition has the following binder classification: Acacia, Alginic Acid, Carbomer, Carboxymethylcellulose sodium, Dextrin, Ethylcellulose, Gelatin, Guar Gum, Hydrogenated vegetable oil type 1, Hydroxyethyl cellulose, Hydroxypropyl methylcellulose, Liquid glucose, Magnesium aluminum silicate, Maltodextrin, Methylcellulose, polymethacrylates, povidone, sodium alginate, starch and zein. Most preferred binder also have an active cleaning function in the wash such as cationic polymers. Examples include ethoxylated hexamethylene diamine quaternary compounds, bishexamethylene triamines or other such as pentaamines, ethoxylated polyethylene amines, maleic acrylic polymers.

5. The compositions herein may also comprise expandable clays. As used herein the term “expandable” means clays with the ability to swell (or expand) on contact with water. These are generally three-layer clays such as aluminosilicates and magnesium silicates having an ion exchange capacity of at least 50 meq/100 g of clay. The three-layer expandable clays used herein are classified geologically as smectites. Example clays useful herein include montmorillonite, volchonskoite, nontronite, hectorite, saponite, sauconitem, vermiculite and mixtures thereof. The clays herein are available under various 5 tradenames, for example, Thixogel #1 and Gelwhite GP from Georgia Kaolin Co., Elizabeth, N.J., USA; Volclay BC and Volclay #325 from American Colloid Co., Skokie, Ill., USA; Black Hills Bentonite BH450 from International Minerals and Chemicals; and Veegum Pro and Veegurn F, from R.T. Vanderbilt. It is to be recognised that such smectite-type minerals obtained under the foregoing tradenames can comprise mixtures of the various discrete mineral entities. Such mixtures of the smectite minerals are suitable for use herein.

6. The compositions of the present invention may comprise a highly soluble compound. Such a compound could be formed from a mixture or from a single compound. Examples include salts of acetate, urea, citrate, phosphate, sodium diisobutylbenzene sulphonate (DIBS), sodium toluene sulphonate, and mixtures thereof

7. The compositions herein may comprise a compound having a Cohesive Effect on the detergent matrix forming the composition. The Cohesive Effect on the particulate material of a detergent matrix forming the tablet or a layer of the tablet is characterised by the force required to break a tablet or layer based on the examined detergent matrix pressed under controlled compression conditions. For a given compression force, a high tablet or layer strength indicates that the granules stuck highly together when they were compressed, so that a strong cohesive effect is taking place. Means to assess tablet or layer strength (also refer to diametrical fracture stress) are given in Pharmaceutical dosage forms: tablets volume 1 Ed. H. A. Lieberman et al, published in 1989. The cohesive effect is measured by comparing the tablet or layer strength of the original base powder without compound having a cohesive effect with the tablet or layer strength of a powder mix which comprises 97 parts of the original base powder and 3 parts of the compound having a cohesive effect.

The compound having a cohesive effect is preferably added to the matrix in a form in which it is substantially free of water (water content below 10% (pref below 5%)). The temperature of the addition is between 10 and 800° C., more pref between 10 and 400° C. A compound is defined as having a cohesive effect on the particulate material according to the invention when at a given compacting force of 3000N, tablets with a weight of 50 g of detergent particulate material and a diameter of 55 mm have their tablet tensile strength increased by over 30% (preferably 60 and more preferably 100%) by means of the presence of 3% of the compound having a cohesive effect in the base particulate material. An example of a compound having a cohesive effect, is sodium diisoalkylbenzene sulphonate.

Detergent Tablet Making Process

The detergent tablets of the present invention can be dosed to the laundry machine via the drawer or directly into the drum, potentially via a dispending device, such as a net.

Tablets can be prepared simply by mixing the solid ingredients together and compressing the mixture in a conventional tablet press as used, for example, in the pharmaceutical industry, in the food industry, or in the detergent industry. The detergent tablets can be made in any size or shape and can, if desired, be coated. The particulate materials used for making the tablet can be made by any particulation or granulation process. An example of such a process is spray drying (in a co-current or counter current spray drying tower) which typically gives low bulk densities 600 kg/m³ or lower. Particulate materials of higher density can be prepared by granulation and densification in a high shear batch mixer/granulator or by a continuous granulation and densification process (e.g. using Lodige™ CB and/or Lodige™ KM mixers). Other suitable processes include fluid bed processes, compaction processes (e.g. roll compaction), extrusion, as well as any particulate material made by any chemical process like flocculation, crystallisation sentering, etc. Individual particles can also be any other particle, granule, sphere or grain.

The particulate materials may be mixed together by any conventional means. Batch is suitable in, for example, a concrete mixer, Nauta mixer, ribbon mixer or any other. Alternatively the mixing process may be carried out continuously by metering each component by weight on to a moving belt, and blending them in one or more drum(s) or mixer(s). A binder, preferably a non-gelling binder; can be sprayed on to the mix of some, or, on the mix of all of the particulate materials, either separately or premixed. For example perfume and slurries of optical brighteners may be sprayed. A finely divided flow aid (dusting agent such as zeolites, carbonates, silicas) can be added to the particulate materials after spraying the binder, preferably towards the end of the process, to make the mix less sticky.

The tablets may be manufactured by using any compacting process, such as tabletting, briquetting, or extrusion, preferably tabletting. Suitable equipment includes a standard single stroke or a rotary press (such as Courtoy™, Korch™, Manesty™, or Bonals™). Tablets prepared should preferably have a diameter of between 40 mm and 60 mm, and a weight between 25 and 100 g. The ratio of height to diameter (or width) of the tablets is preferably greater than 1:3, more preferably greater than 1:2. The compaction pressure used for preparing these tablets need not exceed 5000 kN/m, preferably not exceed 3000 kN/m, and most preferably not exceed 1000 kN/m.

The detergent tablet typically has a diameter of between 20 mm and 60 mm, and typically having a weight of from 10 g to 100 g. The ratio of tablet height to tablet width is typically greater than 1:3. The tablet typically has a density of at least 900 g/l, preferably at least 950 g/l, and preferably less than 2,000 μl, more preferably less than 1,500 g/l, most preferably less than 1,200 g/l.

Incorporation of the Perfume Particle into a Discrete Particle

The discrete particle comprising the perfume particle are preferably manufactured in an extrusion process. The equipment typically used for this invention is a Twin Screw Extruder (TSE), and a Marumerizer® or Spheronizer. A blend of different powder ingredients comprising the perfume particle, is fed into the TSE. Optionally, a free perfume can be added, typically at a level of from 2% to 16%, preferably 6% to 12%, more preferably from 8% to 10% of the final discrete particle. A binder is then incorporated, so that extrudates are formed. These extrudates are cutted and rounded up in a spheronization process, such as in a Marumerizer® (ex. Fuji Paudal).

Packaging

Preferably the detergent tablet of the present invention will be packaged into a humidity resistant package. It has been found that the long term stability of the perfume components and the perfume delivery profile of the detergent tablet will be further improved by packaging the tablets with materials that provide a moisture barrier, expressed as a moisture vapor transmission rate (MVTR), of at less than 1 g H₂O/day/m², preferably less than 0.1 g H₂O/day/m², and more preferably less than 0.02 g H₂O/day/m².

Indeed, it has been found that the stability of the perfumed detergent tablets and its ability to effective release the perfume components is further improved when such materials be protected from atmospheric moisture with a package having specific moisture barrier characteristics. Hydration of powder components is detrimental to the perfumed tablet because deactivation prolongs the dissolution time and may leave residues in the washing machine and/or on fabrics. Further, if there is incomplete dissolution, the perfume carrier material will not be completely released to deposit on the fabric surface such that the benefit delivered will only be a fraction of the target benefit. In addition, where the perfume is entrapped in a moisture sensitive carrier such as zeolite, the perfume will be desorbed upon adsorption of water, especially water vapour. Water vapour can effectively displace about 95-98% of the perfume entrapped inside the zeolite cavity.

The choice of packaging material for the perfumed detergent tablet of the present invention can be determined by following several steps. First determine the critical amount of water that can be adsorbed or absorbed by the perfumed detergent tablet without losing performance, where the loss of performance can be quantified by the level of perfume components in the headspace above or on the dried fabrics, by the incomplete dissolution of the composition/article, etc. Water absorption may be determined by exposing the composition/article to constant humidity and determining the mass gained over time. Then, evaluate the performance (analytical and/or sensory) of each perfumed detergent tablet to determine the critical quantity of water. Second, determine the surface area of the package in which the perfumed tablets will be packaged and sold in the trade. Third, determine the in-trade stability requirement, such as the number of months that the detergent tablet is likely to remain in the package prior to use. The maximum moisture vapour tansmission rate (MVTR) for the detergent tablet may be calculated using the following equation:
MVTR=(Critical Mass of Water)/(Surface Area of Package)/(in-trade stability required)[=] g H₂O/m²/day.

Tabulated values of MVTR provided in technical references generally report data determined at 28-38° C., and 80%-90% relative humidity such that they represent worse case scenario ambient conditions. Selecting the packaging material under these conditions will ensure long term stability of the article. Preferably, the article is packaged so that moisture penetration must occur through a continuous layer, and the moisture vapour transmission rate of the layer is less than 1 g H₂O/m²/day, Preferably less than 0.5 g H₂O/m²/day, more preferably less than 0.1 g H₂O/m²/day, even more preferably less than 0.02 g H₂O/m²/day and still more preferably 0 g H₂O/m²/day, to ensure article stability.

The packaging selected to ensure minimal perfume oil loss from the zeolite, must meet several requirements. Films that are permeable to water vapor will not be sufficient to ensure stability. Determination of effective packaging materials must be done on a case-by-case basis since perfume materials will have various odor detection thresholds, and performance benefits that may be detected even after about 20-40% of the oil is lost from the zeolite.

Also, fragrances are normally composed of volatile compositions, so that a low MVTR prevents not only the ingress of water, but egress of perfume. Materials suitable for this use include mono-layer, co-extruded or laminated films. Preferably the packaging system is composed of vapour metallised bi-oriented polypropylene with an MVTR of less than 1 g/day/m². The film may have various thicknesses. The thickness should typically be between 10 and 150 μm, preferably between 15 and 120 μm, more preferably between 20 and 100 μm, more preferably between 20 and 80 μm and most preferably between 20 and 30 μm.

The packaging system comprises at least a micro-hole. There may also be more than 1 micro-hole. These can be made using a pin. An advantage of using a micro-hole in combination of a material having the claimed MVTR is that the problem of ingress of moisture and the problem of evacuation of gas can be decoupled. Indeed the ingress of moisture is readily controlled by choosing the right MVTR, whereas a micro-hole has only a negligible influence on ingress of moisture because it is present only at some points on the packaging system without modifying the characteristics of the remaining surface of the packaging system and a microhole will not have influence enough if there is no pressure gradient. As a pressure gradient will appear precisely when gas needs to be evacuated to prevent deformation of the packaging system the micro-hole will fulfil its function without significant influence on the ingress of moisture.

The tablets of the invention can be wrapped after being deposed onto the packaging system. A cold seal or an adhesive is particularly suited to the packaging system of the present invention. Indeed a band of cold seal or a band of adhesive may be applied to the surface of the packaging system at a position adjacent to the second end of the packaging system, so that this band may provide the initial seal of the packaging system. In such a case the cold seal band may correspond to a region having a cohesive surface, i.e., a surface which will adhere only to another cohesive surface.

Deposition of Perfume onto Fabric Surfaces

When formulated as a laundry detergent tablet, the method of washing fabrics and depositing perfume thereto comprises contacting said fabrics with an aqueous wash liquor comprising at least 100 ppm of conventional detersive ingredients, including at least 0.1 ppm of the perfume particle. The conventional detersive ingredient can be added separately or formulated within the detergent tablet of the present invention. The detergent tablet works under all circumstances, but is particularly useful for providing odor benefits during the laundering process and on wet and dry fabrics. The method comprises contacting fabrics with an aqueous liquor comprising the conventional detersive ingredients and the perfume particle, such that the perfumed particles are entrained on the fabrics, storing line-dried fabrics under ambient conditions with humidity of at least 20%, drying the fabric in a conventional automatic dryer, or applying heat to fabrics which have been line-dried or machine dried by conventional ironing means (preferably with steam or pre-wetting).

### EXAMPLES

All percentages, parts and ratios are by weight unless otherwise indicated.

### Example 1

### Entrapping Perfume on Porous Carrier Particles

An amount of 170 g of perfume is added at a rate of about 5 g/sec through a perfume nozzle (80 psi, average droplet size of 90 micrometres) to 830 g of Zeolite 13× (ex. UOP Limited—Molsiv Absorbents) under high agitation in single batch Loedige Plow mixer. A cooling jacket at 20° C. is used to remove the heat generated during perfume entrapment (aprox. 280 kJ/kg perfume). The perfume loaded in the zeolite has the following composition:

| Material name | % |
|---|---|
| Violiff | 2.5 |
| Frutene | 15.0 |
| Methyl Iso Butenyl Tetrahydro | 7.5 |
| Pyran | |
| Cymal | 10.0 |
| Florhydral | 15.0 |
| Delta damascone | 15.0 |
| Ionone Beta | 25.0 |
| P.T. Bucinal | 10.0 |

### Example 2

### Perfume Particles in Discrete Particles (Region 2)

TABLE 1

| | A | B | C |
|---|---|---|---|
| Metasilicate | 27.6 | 22.5 | — |
| Sodium Acetate | 13.1 | 13.1 | 13.1 |
| Zeolite A | 1.5 | 1.5 | 1.5 |
| Sodium Bicarbonate | 27.8 | 27.8 | 27.8 |
| Citric Acid | 20.1 | 20.1 | 20.1 |
| Silica | 0.8 | 0.8 | 0.8 |
| Loaded Zeolite | 9.2 | 14.3 | 36.7 |

(1) Particles prepared as in example 1.

Compositions according to Table 1 are mixed during 5 minutes in a Loedige mixer. This mix is fed into a Twin Screw Extruder (TSE ZSK 25 ex. Werner & Pfleiderer) at a level of approx. 74% by weight and then optionally, mixed with approx. 8% of a perfume oil and kneaded with the binder system described below (approx. 15%) into a dough, which is transported to the end of the TSE and pressed through a 2 mm die plate producing extrudates.

These extrudates are dusted with Zeolite A Absorbent grade, ex. ICL (3%) then cut and spheronised in a marumerizer (QJ-230, ex. Fuji Paudal co. Ltd) to obtain the discrete particles. These are cooled down and sieved between 1.0 mm and 3.15 mm. Particle size of the beads is measured using the ASTM D502-89 method and the calculated average PSD is approx. 2 mm.

The binder system used in the above extrusion process comprises 95% wt PEG 4000 and 5% wt PEG 200. The two components are mixed during 2 minutes using a Jankel & Kunkel mixer (KW 20 DZM), and then added to the TSE binder feeder.

The final discrete particles have the compositions described in Table 2 below:

TABLE 2

| Ingredient (% weight) | A | B | C | D | E |
|---|---|---|---|---|---|
| Perfume oil | 8.0 | 8.0 | 8.0 | — | 8.0 |
| Loaded Zeolite (1) | 6.8 | 10.6 | 27.3 | 6.9 | 6.8 |
| Binder system | 14.7 | 14.7 | 14.7 | 21.1 | 14.7 |
| Metasilicate | 20.5 | 16.7 | — | 21.0 | 19.0 |
| Sodium acetate | 9.8 | 9.8 | 9.8 | 10.0 | 9.8 |
| Zeolite A | 4.1 | 4.1 | 4.1 | 4.2 | 4.1 |
| Sodium Bicarbonate | 20.6 | 20.6 | 20.6 | 21.0 | 20.6 |
| Citric Acid | 14.9 | 14.9 | 14.9 | 15.2 | 14.9 |
| Precipitated Silica | 0.6 | 0.6 | 0.6 | 0.6 | 2.1 |
| Dye | 0.03 | 0.03 | 0.03 | 0.03 | 0.03 |

(1) From example 1

### Example 3

### Perfume Particles in Discrete Particles (Region 2)

Process described in example 2 was used to prepare the following discrete particles [optionally 10% of perfume oil and approx. 13% of binder].

TABLE 3

| Ingredient (% weight) | F | G | H | J |
|---|---|---|---|---|
| Perfume oil | 10.0 | 10.0 | 10.0 | — |
| Loaded zeolile (1) | 8.5 | 13.3 | 34.1 | 34.1 |
| Binder system | 12.7 | 12.7 | 12.7 | 23.0 |
| Metasilicate | 18.8 | 14.1 | — | — |
| Sodium acetate | 9.8 | 9.8 | 9.8 | 9.8 |
| Zeolite A | 4.1 | 4.1 | 4.1 | 3.8 |
| Sodium Bicarbonate | 20.6 | 20.6 | 16.7 | 16.7 |
| Citric Acid | 14.9 | 14.9 | 12.1 | 12.1 |
| Precipitated Silica | 0.6 | 0.6 | 0.5 | 0.5 |
| Dyes | 0.03 | 0.03 | 0.03 | 0.03 |

(1) From example 1

### Example 4

### Detergent Tablet Composition

Manufacturing of Region 1 (the Core)

The detergent composition of the core was prepared by admixing the granular components in a mixing drum for 5 minutes to create a homogenous particle mixture. During this mixing, the spray-on's were carried out with a nozzle and hot air using a binder.

Manufacturing of Region 2 (the Discrete Particles)

The discrete particles have been manufactured as in example 2 and have the compositions described in examples 2 and 3 above.

Tablet Manufacturing:

The multi-phase tablet composition was prepared using an Instron 4400 testing machine and a standard die for manual tablet manufacturing. 35 g of the detergent core was fed into the dye of 41×41 mm with rounded edges that has a ratio of 2.5 mm. The mix was compressed with a force of 1,500 N with a punch that has a suitable shape to form a concave mold of 25 mm diameter and 10 mm depth in the tablet. The shaped punch was carefully removed leaving the tablet into the dye. 2.3 g of discrete particles that form the second region were introduced into the mold left in the tablet shape and a final compression of 1,700 N was applied to manufacture the multiphase tablet using a flat normal punch. The tablet is then manually ejected from the dye.

Composition of Region 1 (The Core)

TABLE 4

| Base powder ingredients² | A | B |
|---|---|---|
| Anionic/Cationic agglomerates³ | 36 | 33.5 |
| Anionic Agglomerates⁴ | — | 1.5 |
| Nonionic agglomerates⁵ | 12 | 4.5 |
| Clay extrudate⁶ | — | 8 |
| Layered Silicate⁷ | 1 | 2 |
| Sodium Percarbonate | 10 | 15 |
| Bleach activator agglomerates 1⁸ | 4 | 3 |
| Sodium Carbonate | 12 | 12 |
| EDDS/Sulphate particle⁹ | 0.6 | 0.2 |
| Tetrasodium salt of Hydroxyethane | | |
| Diphosphonic acid | 0.5 | 0.3 |
| Soil Release Polymer | 6 | 2.5 |
| Fluorescer | 0.1 | 0.1 |
| Zinc Phthalocyanide sulphonate encapsulate¹⁰ | 0.05 | 0.01 |
| Suds supressor¹¹ | 2 | 1.5 |
| Soap | — | 0.8 |
| Citric acid | 3 | 4 |
| Sodium Citrate | 3 | 2 |
| Sodium Acetate | 4 | 3 |
| Protease | 0.5 | 0.3 |
| Amylase | 0.2 | 0.05 |
| Cellulase | — | 0.1 |
| Binder system¹² | 1.7 | 3.5 |
| Miscellaneous | to 100% | to 100% |

²Values given in table 4 are percentages by weight of the total detergent tablet.
³Anionic/Cationic agglomerates comprise from 20% to 45% anionic surfactant, from 0.5% to 5% cationic surfactant, from 0% to 5% TAE80, from 15% to 30% SKS6, from 10% to 25% Zeolite, from 5% to 15% Carbonate, from 0% to 5% Carbonate, from 0% to 5% Sulphate, from 0% to 5% Silicate and from 0% to 5% Water.
⁴Anionic agglomerates comprise from 40% to 80% anionic surfactant and from 20% to 60% DIBS.
⁵Nonionic agglomerates comprise from 20% to 40% nonionic surfactant, from 0% to 10% polymer, from 30% to 50% Sodium Acetate anhydrous, from 15% to 25% Carbonate and from 5% to 10% zeolite.
⁶Clay agglomerates comprise from 90% to 100% of CSM Quest 5A clay, from 0% to 5% alcohol or diol, and from 0% to 5% water.
⁷Layered silicate comprises from 90% to 100% SKS6 and from 0% to 10% silicate.
⁸Bleach activator agglomerates 1 comprise from 65% to 75% bleach activator, from 10% to 15% anionic surfactant and from 5% to 15% sodium citrate.
⁹Ethylene diamine N,N-disuccinic acid sodium salt/Sulphate particle comprises from 50% to 60% ethylene diamine N,N-disuccinic acid sodium salt, from 20% to 25% sulphate and from 15% to 25% water.
¹⁰Zinc phthalocyanine sulphonate encapsulates are from 5% to 15% active.
¹¹Suds suppressor comprises from 10% to 15% silicone oil (ex Dow Corning), from 50% to 70% zeolite and from 20% to 35% water.
¹²The binder systems used in compositions A and B are respectively 90% sorbitol/10% water and 85% PEG 4000/15% Cyclohexyldimethanol.

### Example 5

### Coated Detergent Tablet

The detergent tablets of example 4 above (40 g each), can be coated by dipping the tablet into a mixture of 95 g adipic acid with 5 g calcium polystyrene sulphonate resin (ex. Purolite), at a temperature of 160° C.

### Example 6

### Packaged Detergent Tablet

The uncoated tablets of example 4 or the coated tablets of example 5 can be packaged in a flow-wrap of 20 micron vapour metallised (Aluminium) BiOriented Polypropylene film with cold glue pattern.

1. A detergent tablet comprising at least 2 discrete regions and about 0.05% to about 10% by weight of the detergent tablet, of a perfume particle comprising a porous carrier material and a perfume comprised in the pores of said porous carrier material; wherein the perfume particle is comprised at a greater concentration in a second region of the tablet than in a first region thereof.

2. A detergent tablet according to claim 1 wherein the first region is a compacted matrix and the second region is in form of a single or a plurality of coating, layer, discrete particle, insert, dimple, bead and mixtures thereof.

3. A detergent tablet according to claim 1 wherein all perfume particles are comprised in the second region.

4. A detergent tablet according to claim 1 wherein the second region is in the form of a plurality of discrete particles.

5. A detergent tablet according to claim 4 wherein the discrete particles have an average particle size of from about 0.5 mm to about 10 mm.

6. A detergent tablet according to claim 1 wherein the first region is in the form of a shaped body with at least one mould therein and the second region is compressed within the mould.

7. A detergent tablet according to claim 1 wherein the perfume particle is comprised at a level of from about 0.1% to about 5% by weight of the total detergent tablet.

8. A detergent tablet according to claim 7 wherein the perfume particle is comprised at a level of from about 0.1% to about 3% by weight of the total detergent tablet.

9. A detergent tablet according to claim 1 wherein said porous carrier material is a zeolite selected from the group consisting of Zeolite X, Zeolite Y, and mixtures thereof.

10. A detergent tablet according to claim 1 wherein the perfume particle comprises from about 1% to about 60%, and from about 40% to about 99% of the carrier by weight of the perfume particle.

11. A detergent tablet according to claim 10 wherein the perfume particle comprises from about 1% to about 30%, and from about 70% about 99% by weight of the perfume particle.

12. A detergent tablet according to claim 11 wherein the perfume particle comprises from about 10% to about 20%, and from about 80% to about 90% by weight of the perfume particle.

13. A detergent tablet according to claim 1 wherein the perfume loaded into said zeolite carrier has a weighted average ClogP value between about 1.0 and about 16.0

14. A detergent tablet according to claim 1 wherein said perfume loaded into said zeolite carrier comprises a high impact perfume characterized by having: (1) a standard B.P. of about 300° C. or lower at about 760 mm Hg, and; (2) a ClogP, or an experimental logP, of 2 or higher, and; (3) an ODT of less than or equal to about 50 ppb.

15. A detergent tablet according to claim 1 which is further coated with a dicarboxylic acid.

16. A detergent tablet according to claim 17 wherein the dicarboxylic acid is adipic acid.

17. A detergent tablet according to claim 1 further comprising a free perfume.

18. A detergent tablet according to claim 1 wherein the detergent tablet is comprised within a package.

19. A detergent tablet according to claim 18 wherein the package has a water vapor transmission rate of less than about 1 g H₂O/day/m².

20. A detergent tablet according to claim 19 wherein the package has a water vapour transmission rate of less than about 0.5 g H₂O/day/m².

21. A detergent tablet according to claim 20 wherein the package has a water vapour transmission rate of less than about 0.1 g H₂O/day/m².

22. A detergent tablet according to claim 21 wherein the package has a water vapour transmission rate of less than about 0.02 g H₂O/day/m².

23. A detergent tablet according to claim 22 wherein the package has a water vapour transmission rate of 0 g H₂O/day/m².

24. A detergent tablet according to claim 18, wherein said package is a film.

25. A detergent tablet according to claim 24, wherein the film provides a continuous layer moisture barrier.

26. A detergent tablet according to claim 18, where the packaging system comprises at least one micro-hole.

27. A detergent according to claim 26 where the packaging system comprises at least 1 or 2 micro-holes.

28. A detergent tablet according to claim 18, where the packaging system is made using a flow wrapping process.
